(19) United States
(12) Patent Application Publication
(10) Pub. No.: US 2006/0227764 A1
(43) Pub. Date: Oct. 12, 2006

(54) Fax passthrough for a system that includes super G3 fax machines

(76) Inventors: Prasad Miriyala, Union City, CA (US); Mehryar Khalili Garakani, Westlake, CA (US); Praveen Kumar Konda, San Jose, CA (US)

Correspondence Address: MARGER JOHNSON & MCCOLLOM, P.C., 210 SW MORRISON STREET, SUITE 400, PORTLAND, OR, 97204, US

(21) Appl. No.: 11/101,806

(22) Filed: Apr. 7, 2005

(51) Int. Cl. H04L 12/66

(52) U.S. Cl. 370/352

(57) ABSTRACT

A method and system for fax passthrough that can detect fax calls and which can distinguish between fax calls and modem calls. Both V.21 flags and the CM fax signals are detected to determine if a call is a fax call. If a call is from a G3 fax machine, the v.21 flags will be detected. On the other hand if the call is from a SG3 fax machine the CM fax signal will be detected. The method and system therefore detects fax calls and it distinguishes between fax and modem calls in a fax passthrough system.

### RELATED APPLICATION

The present application is related to Application Ser. No. 10/743,980 filed Dec. 22, 2003 (docket c-316) and to application Ser. No. 11/058,491 filed Feb 14, 2005 (docket c-421). The entire content of the two above listed prior filed applications is hereby incorporated herein by reference

### FIELD OF THE INVENTION

The present invention relates to packet networks and more particularly to inter connecting fax machines over an IP network using fax passthrough.

### BACKGROUND OF THE INVENTION

In this patent application, the following common abbreviations will be used:
TDM Time Division Multiplex
IP Internet Protocol
VoIP Voice Over IP
G3 Group 3 fax machines
SG3 Super Group 3fFax machines
bps bits per second
SIP Session Initiation Protocol
CED Called Subscriber Identifier
DIS Digital Identification Signal
DCS Digital Command Signal
CFR Confirmation to Receive Signal
CM Call Menu
FSK Frequency shift keying

When fax machines were first developed, two fax machines were generally interconnected using a conventional analog telephone circuit. An analog circuit connection does not need to know if a call is a voice call or a fax call. An analog circuit connection handles both voice and fax in the same way.

Currently, with the development of voice over IP (hereinafter VoIP) networks, many fax messages are transmitted over packet networks. When fax machines are interconnected over a packet network, the initial connection is typically made using a voice grade connection. Subsequently, when the actual fax transmission begins, the network connection switches to either a fax relay or to a fax passthrough protocol. The following publicly available document describes transmission of faxes over an IP network: “Cisco IOS Fax Services over IP Application Guide” Chapter 1, “Fax Services over IP”. This document is available on the Internet at the Cisco Corporation web site. The content of the above referenced document is hereby incorporated herein in its entirety.

Fax machines known as G3 fax machines are capable of operating at top speed of 14,400 bps. More modern fax machines, known as SG3 fax machines are capable of operating at speeds of up to 33,600 bps. In general, G3 fax machines utilize protocols known as the V.17, V.21, V.27 and V.29 fax protocols. SG3 fax machines utilize a protocol known as the V.34 protocol.

The V.17, V.21, V.27 and V.29 and V.34 protocols are standard protocols that have been documented and published by International Telecommunication Union standard committees. These protocols are discussed in a paper entitled “Definition of Events for Modems, Fax, and Text Telephony Signals” by H. Schulzrinne of Columbia University, S. Petrack of eDial and T. Taylor Nortel, dated Feb. 17, 2005 and designated as an “Internet-Draft”. The content of the above referenced paper is hereby incorporated herein in its entirety.

When fax machines are connected over an analog line, the machines use a handshaking procedure to determine the highest speed at which they are capable of connecting. If a connection can not be made at the highest speed, the machines typically “falls back” and try to make a connection at a slower speed. For example, when a SG3 fax machine connects to a G3 fax machine over a analog connection the SG3 fax falls back in speed and operates at the speed of the G3 machine. The process by which two fax machines exchange information to determine at which speed they should operate is termed “hand shaking”.

When two fax machine are connected over a VoIP network, the initial handshaking can take place over a voice grade connection; however, once the connection has been made, the gateways must switch to a different type of connection. Two techniques that are in widespread use for transmitting fax over a VoIP network are termed “fax relay” and “fax passthrough”. The present invention is relevant to fax transmissions using fax passthrough.

In a system using fax passthrough, the initial handshaking between the fax machines is done using a voice grade connection. Messages between the fax machines are exchanged using a messaging protocol such as H.323 or SIP. The codec normally used for a voice grade connection are, for example, voice grade codecs such as those known as 729, 726 or 723. However, codecs such as voice grade codecs 729, 726 or 723 are not suitable for fax transmission. For fax transmission a codec, such as the codec known as 711, is required. A 711 codec uses more bandwidth, but it has a low probability of distorting fax signals.

The present invention is directed to a system and technique for detecting that a call is a fax call in system using fax passthrough, and for switching to a codec suitable for fax transmission over an IP network.

Some prior art systems determine that a call is not a voice call by detecting a 2100 Hz tone at the beginning of a call. Such a tone can be either
1) The CED signal generated by older fax machines
2) The Ans tone generated by G3 fax machines or
2) the AnsAm tone generated by SG3 fax machines.

The Ans and AnsAm tones are not unique to fax calls. They are also generated by during the setup of modem calls. Thus, the above technique does not distinguish between fax and modem calls. Another prior art technique detects V.21 flags. These are relatively easy to detect. However, SG3 fax calls do not generate V.21 flags.

Thus, the prior art detection methods can not be used in a fax passthrough system where the user desires to treat fax and modem calls in different manners.

### SUMMARY OF THE PRESENT INVENTION

The present invention relates to a method and system for transmitting fax calls using fax passthrough. With the present invention, during a fax passthrough call setup process, a detection technique is used that can detect fax calls and which can distinguish between fax calls and modem calls.

With the present invention, during fax passthrough call setup, both V.21 flags and the CM fax signals are detected to determine if a call is a fax call. If a call is from a G3 fax machine, the v.21 flags will be detected. On the other hand if the call is from a SG3 fax machine the CM fax signal will be detected.

The method and system of the present invention therefore detects fax calls and it distinguishes between fax calls and modem calls during the call setup procedure for fax passthrough.

### BRIEF DESCRIPTION OF THE FIGURES

FIG. 1 is an overall system diagram.

FIG. 2 is a block diagram of a gateway.

FIG. 3 is a block diagram of the call setup code.

FIG. 4 is a block flow diagram illustrating the operation of the system.

### DETAILED DESCRIPTION

Several preferred embodiments of the present invention are described and discussed below with reference to the drawings listed above. The drawings illustrate exemplary preferred embodiments of the invention and the operation of such embodiments. It should, however, be noted that this invention may be embodied in many different forms and the invention should not be construed as being limited to the embodiments set forth herein.

The following description conveys, in full, clear, and concise terms, to one skilled in the art, how to make and use the invention. In the drawings, the size of the boxes is not intended to represent the size of the various physical components. The same reference numerals are used to denote the same elements throughout the drawings.

Only the parts of the various units that are relevant to an explanation of the present invention are shown and described herein. It should be understood that the units shown in the drawings and described herein have other conventional parts in addition to those shown and described herein. Many conventional parts of the embodiments, and many conventional operations performed by the embodiments, are not shown or described herein in that such parts and operations are known to those skilled in the art.

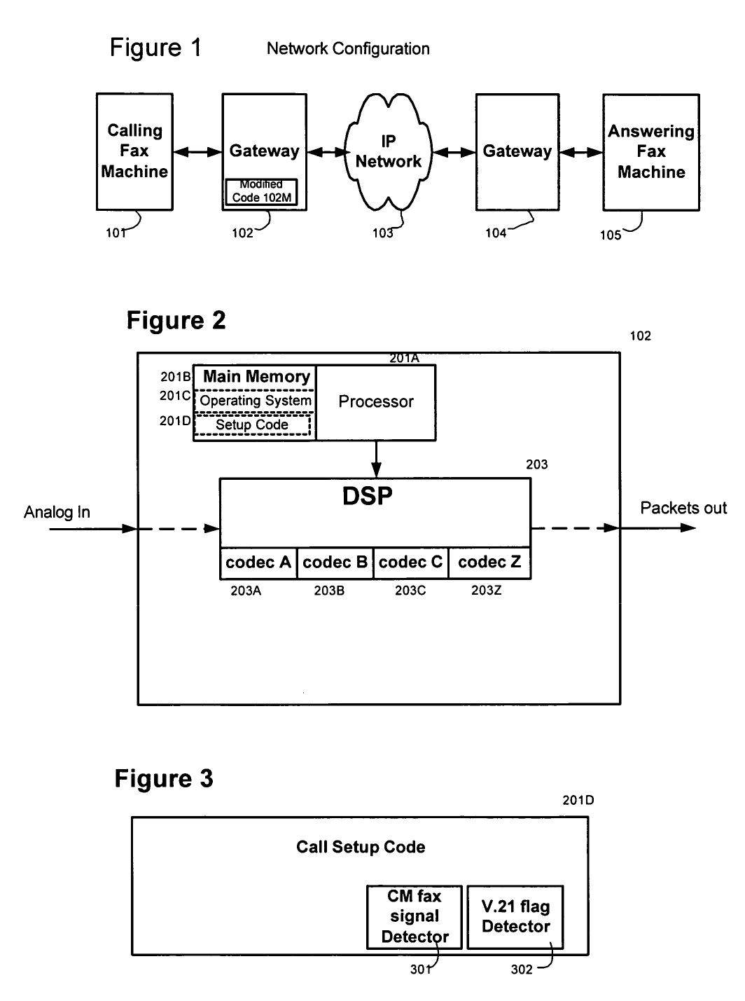

The present invention relates to the transmission of fax over IP networks using fax passthrough. FIG. 1 is an overall system diagram of a system that includes a calling fax machine 101 and an answering fax machine 105. Fax machine 101 is connected to a network gateway 102 and fax machine 105 is connected to a network gateway 104. The gateways 102 and 104 communicated over a packet network 103. The network 103 can be the Internet. The overall configuration shown in FIG. 1 is a conventional configuration used when faxes are transmitted over an IP network. However, in the embodiment described here, gateway 102 includes some modified code indicated by block labeled 102M in FIG. 1. FIG. 2 is a more detailed block diagram of the relevant parts of gateway 102.

The gateway 102 includes an embedded processor 201A that controls the gateway. Processor 201A has an associated main memory 201B, an associated operating system 201C and call setup code 201D. The gateway also includes a number of DSP processors (only one of which is shown in the figure). The DSPs are the units in the gateway that actually processes each call that passes through the gateway. The DSP also has a number of associated codecs designated codec A, codec B, codec C and codec Z in the figure. These codecs are actually programming code stored in the DSP by the processor 201A during call setup. While only four codecs are shown in the figure, there may many more such codecs.

As indicated by the arrows in the figure, the gateway receives analog signals and it generates packets that are passed to the network. The line form the input to the DSP and from the DSP to the output are shown by a dotted line, in that for any call, the operating system selects a particular DSP to handle the call during the call setup procedure. The particular DSP shown is the one selected to handle a particular call; however, other calls go to other DSPs. The parts of the gateway, other than the setup code 201D are conventional.

The fax machines 101 and 105 may be either G3 or SG3 fax machines. Each different type of fax machine operates according to a particular protocol for that type of fax machine. While the figure shows a fax machine connected to the gateway 102, other devices such as telephones or modems may also be connected to the gateway. Furthermore, a gateway will have many call originating units (such as fax machines, modems etc) connected to the gateway. When the gateway 102 receives a call on a particular input port, it does not know if the call is a voice call, a fax call or a modem call. Furthermore, if a call is a fax call, the gateway does not know if the calling unit is a G3 or a SG3 fax machine.

Fax calls may be handled by a gateway using either what is known as a fax relay procedure or by using what is know as a fax passthrough procedure. The present invention relates to systems that use fax passthrough.

In fax passthrough, an RTP connection is established between the sending and receiving gateways. Typically, the length of the playout buffer is increased to insure that packets are not lost. On the other hand, fax relay does not establish an RTP connection and the transmission utilizes a lower amount of bandwidth compared to fax passthrough. However, in some situations users prefer to use fax passthrough rather than fax relay.

The system shown in FIG. 1 is set up to utilize fax passthrough. The gateways 102 and 104 are configured to use fax passthrough for fax calls. As described below, the system can both detect fax calls and it can distinguish between fax and data modem calls.

It is conventional for the call setup code in a gateway to handle voice calls, fax calls and modem calls in a different manner. During a setup procedure an operator sets up the gateway so that it will handle fax, modem and voice calls in a particular manner. For example, voice calls may be handled using a codec which utilizes a relative small amount of bandwidth, such as the codecs know as G.727, G.728, and G729. However, with fax passthrough, the fax data must be transmitted using a fax codec such as a G.711 codec. The G.711 codec uses a relatively large amount of bandwidth but its very sensitive to lost packets.

The system shown in FIG. 1 detects fax calls. It can differentiate between fax and modem calls so that fax and modem calls can be handled in different ways. For example, fax calls may be transmitted and modem calls may be blocked. Users may have a wide variety of reasons for wanting to handle, fax and modem calls in a different manner. With the embodiment shown in FIG. 1, the system detects fax and modems calls, but it distinguishes between fax and modem calls. The user is free to make whatever choices he may desire with respect to what he does with fax calls and what he does with modem calls. In the specific embodiment described here, fax calls are transmitted using a G.711 codec and modem calls are blocked. However, a user may make other choices as to how he would like the different type of calls handled.

As illustrated in FIG. 3, the setup code 201D includes a V.21 flag detector 301 and a CM fax signal detector 302. The V.21 flag detector 302 detects V.21 flags generated during the handshaking procedure between two fax machines. These flags are unique to the fax setup procedure for G3 fax machines. The CM fax signal detector 301 detects the generation of a CM fax signal generated during a handshaking procedure between two fax machines. The internal constructions of such detectors is conventional.

A CM signal is a series of bits that indicates the capabilities of the calling device. The CM signal includes a series of bits that uniquely identify the calling device as a fax machine. The bits in the CM signal that uniquely identify the calling device as a fax machine is what is referred to herein as a CM fax signal.

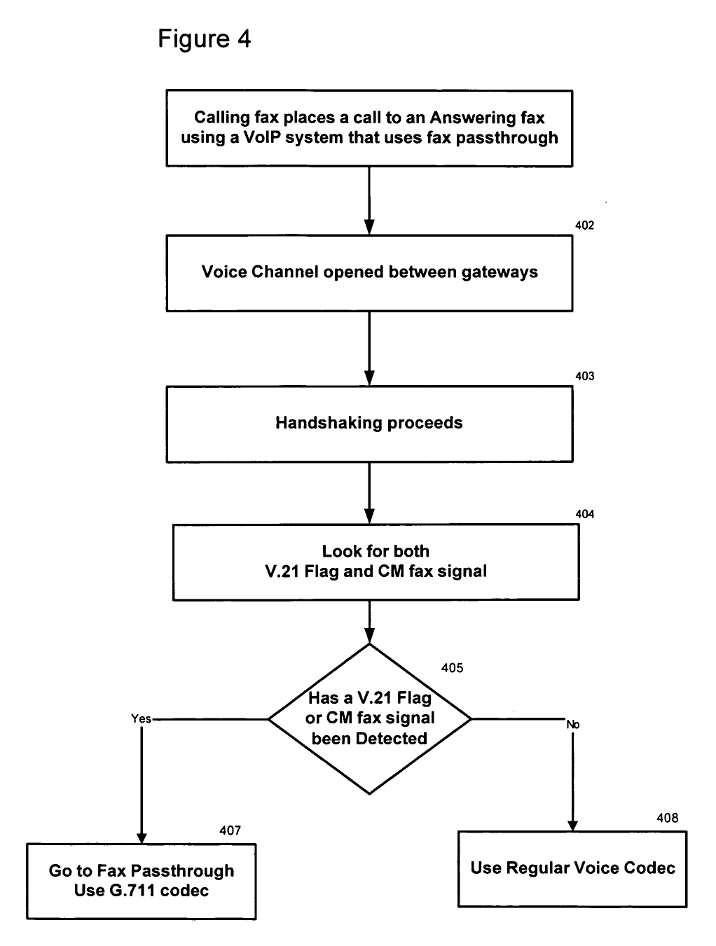

The embodiment shown in FIG. 1 operates as illustrated by the block diagram in FIG. 4. However, prior to explaining the operation illustrated in FIG. 4, it will be useful to briefly set out the standard handshaking procedure used by G3 and SG3 fax machines. From these procedure, it can be seen where the detection process used by the embodiment shown in FIG. 1 comes into operation.

It is also noted that as is conventional, if a SG3 fax places a call to a G3 fax, the calling fax machine falls back to G3 operation. Likewise, if a G3 fax places a call to an SG3 fax, the G3 set up procedure is used. This fall back procedure is conventional.

If the called fax machine is a G3 fax, the V.21 handshaking process proceeds as follows:
1) The calling fax machine places a call to the answering fax machine via a voice connection.
1) The answering fax machine answers the call and issues a CED signal. The CED signal is 2100 Hz tone generated to indicate that the answering machine is a fax.
2) After the CED tone, the answering fax machine issues a DIS signal which indicates the capabilities of answering fax machines. The DIS signal is a 1750 Hz FSK signal, with an HDLC frame structure including a V.21 flag.
3) The calling machine issues a DCS signal in response to the DIS signal. The DCS signal indicates what type of coding and resolution will be used for the call.
4) The answering machine issues a CFR signal to indicate whether or not the DCS and training signals have been successfully received.
5) The transmission then proceeds.

The handshaking operation between two V34 enabled (SG3) fax machines is as follows:
1) The calling fax machine places a call to the answering fax machine via a voice connection.
2) The answering fax machine answers and issues an AnsAm signal. The AnsAm signal is a 2100 Hz tone, with phase reversals at 450 ms intervals, and a 15 Hz amplitude modulation.
3) When the calling fax machine receives the AnsAm signal, it issues a CM signal. The CM signal is a FSK modulated signals at 300 bps. The CM signal carries information indicating that the calling unit is a fax machine and information concerning what protocols are supported by the fax machine that transmitted the cm signal.
4) When the answering fax machine receives the CM signal, it decides which protocol to utilize and it issues a JM signal. The JM signal has a structure similar to the CM signal and carries information concerning which protocol should be used for the call.
5) After the calling fax machine receives the JM signal it eventually switches to the protocol specified by the JM signal and it begins transmitting fax information.

The technique used by the embodiment in FIG. 1 to determine if a call is a fax call is illustrated in FIG. 4. The end point of this process is to determine if the gateways should use a G.711 codec in order to handle the call in fax passthrough mode once the setup process is complete.

The process begins when a calling fax machine 101 makes a call on a VoIP system that uses fax passthrough as indicated by block 401. The gateway 102 opens a voice channel to gateway 104 as indicated by block 402. Next the conventional call setup procedure begins and the fax machine perform the conventional handshaking as indicated by block 403.

As indicated by block 404, the detectors monitor the bit streams transmitted between the gateways during the call setup process. The setup procedure transmits call setup data between the gateways either using the H.323 protocol, the SIP protocol or some other similar data transmission protocol. How the setup data is transmitted between gateways is not relevant to the present invention. However as the bit stream is transmitted during call setup, the bit steam is monitored by V.21 detector 301 and by CM fax signal detector 302. This monitoring function is indicated by block 404.

If either a V.21 flag is detected or if a CM fax signal is detected by detectors 301 and 302, the setup procedure will signal the DSP to use a G.711 codec for the call as indicated by block 407.

If neither a V.21 flag or a CM fax signal is detected by the detectors 301 and 302, the setup procedure will signal the DSP to use a conventional voice codec such as a G.729, G.728 or G.727 as indicated by block 408. Which particular voice codec is used is determined in a conventional manner.

In summary, the embodiment shown relates to a system that is using fax passthrough. The embodiments looks for both a V.21 flag or a CM fax signal during the handshaking procedure. If either a V.21 flag or a CM fax signal is detected during call setup, after the call setup is complete, the system switches to a G.711 fax codec. It is noted that while the specific embodiment described here utilizes a G.711 codec for fax calls, other embodiments utilize other codecs which have characteristics similar to those of the G.711 codex. Such codecs are herein referred to as fax codecs.

It is noted that in the embodiment shown the modified setup code is only in the gateway to which the fax machine is connected. In other embodiments, the modified setup code is in the gateway connected to the Answering fax machine. Thus the modified code can be in either one of the gateways or it can be in both of the gateways.

While the invention has been shown and described with respect to preferred embodiments thereof, it should be understood that those skilled in the art can make a wide variety of changes in the form and detail of the embodiments, without departing from the scope and sprit of the invention. The invention is limed only by the appended claims.

I claim:

1) A method of setting up a call in a VoIP system that utilizes fax passthrough to handle fax calls over a packet network, said method comprising,
monitoring the call setup process for both a V.21 flag and a CM fax signal, and
switching to a fax codec for the fax passthrough transmission at the end of the call setup process if either a V.21 flag or a CM fax signal is detected during said call setup process.

2) The method recited in claim 1 wherein said fax codec is a G.711 codec.

3) The method recited in claim 1 wherein said call is from a first fax machine to a second fax machine.

4) The method recited in claim 3 wherein said first fax machine and said second fax machine are from the group including G3 and SG3 fax machines.

5) The method recited in claim 1 wherein a voice grade channel is used to communicate between said fax machines during said call setup provess.

6) The method recited in claim 1 wherein said calls are transmitted over the Internet.

7) The method recited in claim 3 wherein said fax machines are connected to said network by gateway devices.

8) A method for handling a call from a calling fax machine to an answering fax machine in a VoIP network that utilizes fax passthrough for fax calls, said method comprising,
opening a voice grade channel between said calling fax machine and said receiving fax machine during a call setup process for said call,
monitoring said voice channel for both a V.21 flag and a CM fax signal during said call setup process, and
changing to a fax codex if either a V.21 flag or a CM fax signal is detected during said call setup process.

9) The method recited in claim 8 wherein said fax codec is a G.711 codec.

10) The method recited in claim 8 wherein said calling fax machine and said answering fax machines are from the group including G3 and SG3 fax machines.

11) The method recited in claim 8 wherein said network is the Internet.

12) The method recited in claim 8 wherein said calling fax machine is connected to said network by a first gateway device and said answering fax machine is connected to said network by a second gateway device.

13) A system for handling a call from a calling fax machine to an answering fax machine in a VoIP network that utilizes fax passthrough for fax calls, said system including:
first means for opening a voice grade channel between said calling fax machine and said receiving fax machine during a call setup process for said call,
second means for monitoring said voice channel for both a V.21 flag and a CM fax signal during said call setup process, and
third means changing to a fax codex if either a V.21 flag or a CM fax signal is detected during said call setup process.

14) The system recited in claim 13 wherein said fax codec is a G.711 codec.

15) The system recited in claim 13 wherein said calling fax machine and said answering fax machine are from the group including G3 and SG3 fax machines.

16) The system recited in claim 13 wherein a voice grade channel is used to communicate between said calling and said answering fax machines during said call setup process.

17) The system recited in claim 13 wherein said calls are transmitted over the Internet.

18) The system recited in claim 13 wherein said fax machines are connected to said network by gateway devices.

19) A computer usable medium having computer readable program code embodied in said medium for causing a system to perform the method recited in claim 1.

20) A computer readable medium having stored thereon sequences of instructions for performing the method recited in claim 8.
